(19) United States
(12) Patent Application Publication
(10) Pub. No.: US 2011/0309918 A1
(43) Pub. Date: Dec. 22, 2011

(54) System and Method for Compensating for Aging Haptic Actuators

(75) Inventor: Erin B. Ramsay, Montreal (CA)

(73) Assignee: Immersion Corporation

(21) Appl. No.: 12/817,303

(22) Filed: Jun. 17, 2010

(51) Int. Cl. G08B 6/00

(52) U.S. Cl. 340/407.1

(57) ABSTRACT

Systems and methods for compensating for the effects of aging on actuators are provided. For example, the system may obtain and/or otherwise maintain aging information of an actuator. Based on the aging information, the system may determine a compensation factor. Using the compensation factor, the system may adjust a control signal that causes the actuator to generate a haptic effect. The system may output the control signal to the actuator. In this manner, the system may compensate for the effects of aging on the actuator by adjusting the control signal according to the age of the actuator.

### FIELD OF THE INVENTION

The invention relates to systems, devices, and methods for modeling and compensating for the effects of aging on haptic actuators.

### BACKGROUND OF THE INVENTION

Haptic feedback provides a user with touch sensation that enriches a user interface experience. Various devices have incorporated haptic feedback in order to convey information by touch sensation to the user. For example, video game controllers, communication devices such as cellular phones, computer peripherals such as a computer mouse, and other devices associated with user interfaces use haptic feedback to enrich the user interface experience. Typically, these devices provide a control signal to one or more actuators (i.e., haptic feedback mechanisms including, for instance, a rotary actuator, a piezoelectric actuator, a solenoid, and/or other haptic feedback generating mechanism) in order to generate the haptic feedback. The control signal may vary the magnitude of force, the type of force such as a vibration or a jolt sensation, and/or other characteristic of the haptic feedback that is output by an actuator. In other words, a desired force and/or type of haptic feedback may be designed by providing different control signals to the actuator.

Such control signals are based on an assumption that the performance of the actuator does not change over time. For example, a video game developer may design haptic effects for a haptic-enabled game controller based on an assumption that an actuator of the game controller will perform consistently as it ages.

However, actuator performance may vary according to the age (i.e., passage of time and/or use) of the actuator. In other words, aging may have effects on actuator performance. Such effects may include, for instance, changes in behavior of the actuators with use and/or time that results in inconsistent actuator performance as the actuators age. For example, given a control signal, a spinning mass actuator having brushes tends to generate stronger haptic feedback after a break-in or wear-in period as compared to before the break-in period (when the motor is new). After the break-in period, the motor may wear down and generate weaker haptic feedback as the motor ages given the same control signal. Thus, given the same control signal the actuator may provide weaker haptic feedback when the actuator is old as compared to when the actuator is new and/or broken-in.

Existing haptic feedback systems do not address such performance variance. For example, haptic effects from an actuator of a haptic-enabled game controller may be inconsistent over time, providing the user with different haptic effects when the actuator is new as compared to when the actuator is old. As a result, the game controller may not provide the user with the desired haptic effects as the actuator ages.

These and other drawbacks exist.

### SUMMARY OF THE INVENTION

Various systems, devices, and methods are described that may compensate for the effects of aging on a haptic actuator. For example, the method may include obtaining and/or otherwise maintaining aging information of an actuator and determining a compensation factor based on the aging information. The method may include adjusting a control signal, which may cause the actuator to generate a haptic effect, to be applied to the actuator based on the compensation factor. The method may include outputting the adjusted control signal to the actuator thereby compensating for an age of the actuator. In this manner, various systems, devices, and methods may generate a control signal that compensates for the effects of aging on an actuator by determining or otherwise predicting the effects of aging on the actuator.

### BRIEF DESCRIPTION OF THE DRAWINGS

FIG. 1 is a block diagram of an exemplary system for compensating for the effects of aging on haptic actuators, according to various implementations of the invention.

FIG. 2a is a block diagram of an exemplary system for compensating for the effects of aging on haptic actuators, according to various implementations of the invention.

FIG. 2b is a block diagram of an exemplary system for compensating for the effects of aging on haptic actuators, according to various implementations of the invention.

FIG. 3a is a two-dimensional graph illustrating an exemplary of a force output profile of an actuator as the haptic actuator ages.

FIG. 3b is an example aging offset table illustrating an exemplary voltage parameter that is varied to compensate for the effect of the age of the haptic actuator, the force output profile of which is depicted in FIG. 3a.

FIG. 4 is a flow diagram of an exemplary process for compensating for the effects of aging on haptic actuators, according to various implementations of the invention.

FIG. 5 is a flow diagram of an exemplary process for compensating for the effects of aging on haptic actuators, according to various implementations of the invention.

### DETAILED DESCRIPTION OF THE INVENTION

Various implementations of the invention relate to systems, devices and methods for compensating for the effects of aging on haptic actuators. For example, the system may obtain or store aging information, which may indicate the age (i.e., usage, passage of time, and/or condition) of a haptic actuator. The aging information may be used to generate a compensation factor that compensates for the effects of age on the haptic actuator. The system may use the compensation factor to adjust a control signal that causes the actuator to output haptic effects, thereby generating a control signal that compensates for the age of the actuator. In other words, the system may calibrate a control signal that compensates for the effect of the age of the actuator by providing different control signals depending on the age of the actuator, thereby causing the actuator to generate consistent haptic effects as the actuator ages.

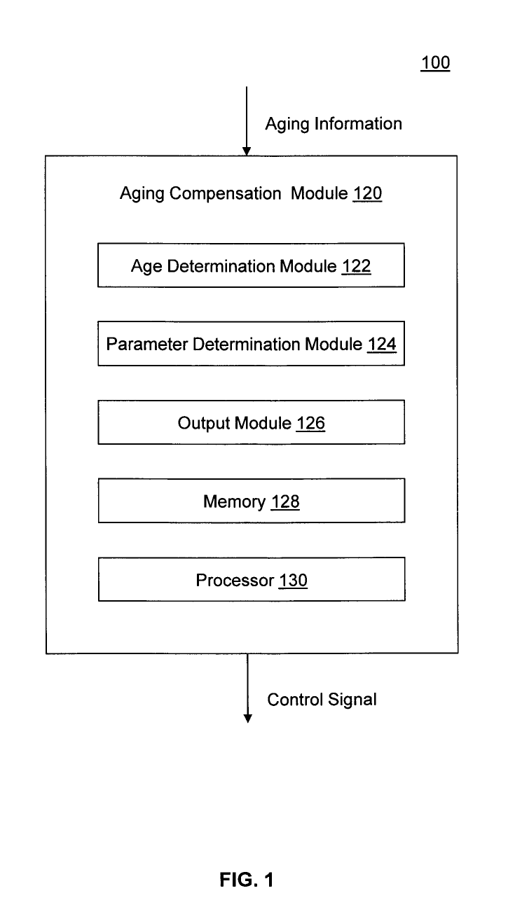

FIG. 1 is a block diagram of an exemplary system 100 for compensating for the effects of aging on haptic actuators, according to various implementations of the invention. System 100 may include an age compensation module 120 that obtains and/or stores aging information of one or more haptic actuators (“the actuator” for convenience; not otherwise illustrated in FIG. 1). Through various modules, age compensation module 120 may assess the age of the actuator based on the aging information. In some implementations of the invention, age compensation module 120 may adjust a control signal that compensates for the effect of the age of the actuator. In some implementations of the invention, age compensation module 120 may generate a compensation factor to be applied to the control signal that compensates for the effect of the age of the actuator.

Aging compensation module 120 may include, among other things, an age determination module 122, a parameter determination module 124, an output module 126, a memory 128, a processor 130, and/or other suitable modules.

According to various implementations of the invention, age determination module 122 may obtain the aging information by retrieving or otherwise receiving the aging information. The aging information may include, for instance, an aging variable that indicates the age of the actuator, one or more measured characteristics of the actuator (such as rotation speed of a rotating actuator, a type of actuator (because different types of actuators may age differently), and/or other aging information that indicates the age of the actuator. For example, an actuation history may be tracked and/or stored in a memory such as memory 128. The actuation history may include a total number of actuations, accumulated power usage (e.g., based on time and/or voltage of the command using known impedance of an actuator), accumulated “on time” that indicates instances that voltage is applied to the actuator, and/or other history information that indicates actuator age.

According to various implementations of the invention, age compensation module 120 may assess and compensate for the age of the actuator. “Age” of the actuator includes any metric (such as the aging information) that indicates one or more characteristics of the actuator that affects performance of the actuator. According to various implementations of the invention, the age includes metrics that measures one or more characteristics of the actuator that result in inconsistent performance of the actuator over time or usage.

According to various implementations of the invention, age determination module 122 may determine the age of the actuator by obtaining the aging variable. In some implementations of the invention, “obtaining” includes tracking the aging variable in an open-loop manner. In some implementations of the invention, the aging variable may be stored in a memory such as memory 128 and/or other storage for later retrieval. According to various implementations of the invention, the aging variable may be updated at various intervals as the actuator ages so that the aging variable reflects the current age of the actuator.

According to various implementations of the invention, the aging variable may indicate a usage age of the actuator. In other words, the aging variable may indicate the age of the actuator based on the frequency and/or the duration in which the actuator has been actuated. For example, the aging variable may be a number or other value that represents the number of instances that the actuator has been actuated and/or a length of time that the actuator has been actuated. In this manner, the age of the actuator may be determined based on actual usage of the actuator.

According to various implementations of the invention, the number of instances that the actuator has been actuated may be obtained by counting the number of control signals that have been output to the actuator, obtaining sensor data from a sensor coupled to the actuator (not shown in FIG. 1) that indicates instances in which the actuator has been actuated, and/or other techniques of counting the number of instances that the actuator has been actuated.

According to various implementations of the invention, the duration in which the actuator has been actuated may be obtained by measuring the duration in which the control signal and/or current is output to the actuator, obtaining sensor data from the sensor that indicates the duration in which the actuator is actuated, and/or other techniques of measuring the duration in which the actuator has been actuated.

According to various implementations of the invention, the aging variable may indicate a temporal (i.e., time-based) age of the actuator. For example, the aging variable may include a length of time that has elapsed since a reference point. The reference point may be a time indicating a date of manufacture, a time indicating an instance in which the actuator was actuated for the first time, and/or other time that establishes a starting point in which to measure time. In this manner, the aging variable may indicate the temporal age of the actuator (such as amount of time elapsed since a reference date).

According to various implementations of the invention, age determination module 122 may determine the age of the actuator by obtaining sensor information from a sensor coupled to the actuator. The sensor may be an accelerometer, a current draw sensor, a vibrometer, and/or other suitable sensor.

According to various implementations of the invention, the sensor information may include one or more measurements and/or other characteristics of the actuator while the actuator is actuated. For example, an accelerometer coupled to a rotary actuator may measure the magnitude of rotational force exerted by the rotary actuator. Such measured force may indicate the age of the actuator given a particular control signal. In other words, given the particular control signal, the rotary actuator may be expected to exert a particular force at a particular age. Thus, the actuator may output different forces at different ages, thereby enabling a determination of the age of the actuator based on the measured force.

According to various implementations of the invention, parameter determination module 124 may determine the compensation factor. In some implementations, the compensation factor may include one or more parameters that are used to adjust a control signal that compensates for the effect of the age of the actuator indicated by the aging information. In other words, parameter determination module 124 may determine the compensation factor to generate the control signal using one or more parameters that are based on the aging information. The one or more parameters may include, for instance, a magnitude of vibration, a frequency of vibration, a voltage supplied to the actuator, and/or other parameters that affect operation of the actuator. By controlling operation of the actuator based on the aging information, the compensation factor and/or the one or more parameters may facilitate consistency of operation of the actuator even though performance of the actuator changes over time. In some implementations of the invention, the control signal may be modified to achieve control concepts such as kickpulses, overdriving, braking, overbraking, and/or other control concepts that can be used to shape the desired output. For example, a kickpulse may cause enhanced voltage levels to the actuator in order to decrease rise time. When the enhanced voltage exceeds the nominal voltage of the actuator, the voltage may become an overdrive pulse. By controlling the duration of a negative voltage braking pulse, the output model of the actuator can also be affected.

According to various implementations of the invention, parameter determination module 124 may predict a behavior of the actuator as the actuator ages, thereby facilitating generation of the one or more parameters to compensate for such behavior. The predicted behavior may be based on the age of the actuator, the type of the actuator (because different types of actuators may age differently), the type of device in which the actuator is coupled, and/or other suitable factors that may contribute to effects of aging on the actuator.

According to various implementations of the invention, parameter determination module 124 may predict the behavior by generating a model of the actuator. The model may predict changes to the performance of the actuator as the actuator ages. For example, the model may predict the break-in period discussed above and its corresponding effects on the performance of the actuator, thereby enabling age compensation module 120 to compensate for the effects of the break-in period.

According to various implementations of the invention, parameter determination module 124 may update the model based on the age of the actuator. For example, when the actuator has achieved a particular age, the model of the actuator may be updated in order to adjust to or otherwise take into account the particular age.

As previously noted, different types of actuators may age differently (in addition, actuators of the same type but from different manufacturers and different motors of actuators may age differently). Thus, according to various implementations of the invention, parameter determination module 124 may generate different models for different types of actuators. Thus, each type of actuator may be modeled in order to predict their respective behaviors over time.

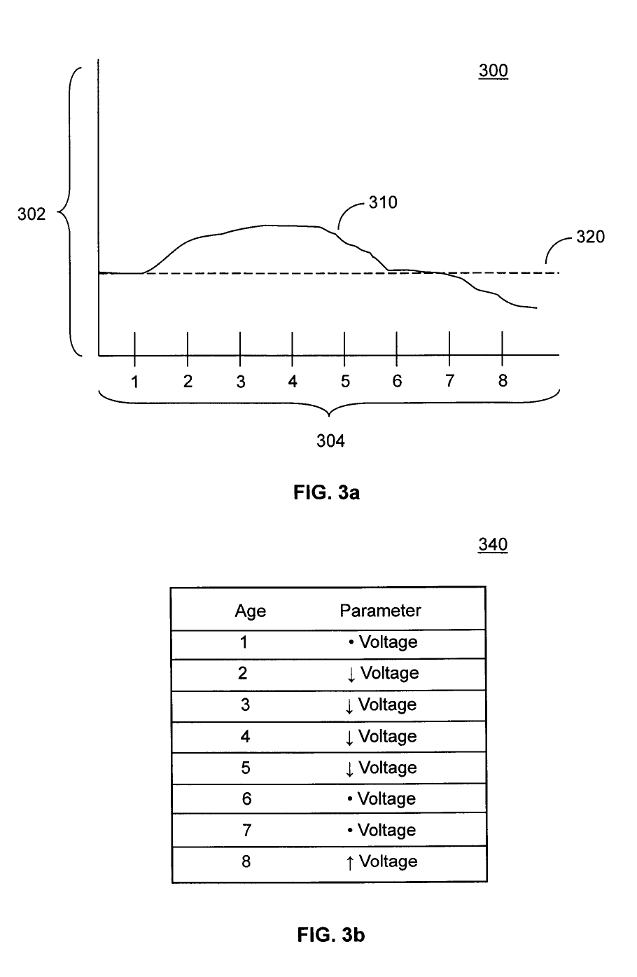

According to various implementations of the invention, parameter determination module 124 may generate the one or more parameters based on an aging offset table (such as the example offset table illustrated in FIG. 3B). The aging offset table may include, for example, a mapping of the aging information (such as the aging variable) to compensation factors. In other words, the aging information may correspond to the one or more compensation factors such that given particular aging information, parameter determination module 124 may determine a particular compensation factor that compensates for the age of the actuator. In this manner, parameter determination module 124 may perform a lookup of the compensation factor using the aging information.

According to various implementations of the invention, the aging offset table may be generated using the model of the actuator. As previously noted, the model may predict the behavior of the actuator over time. Thus, the model may predict different performance at different ages of the actuator. For example, the model may predict that the actuator will generate greater force after the break-in period as compared to before the break-in period. In addition, oftentimes actuators may experience a drop in performance as the actuator ages. The model may predict when the break-in period, drop in performance, or any other performance change occurs, thereby mapping the break-in period or other performance change to different ages of the actuator. In this manner, the aging offset table may associate an age of the actuator with the break-in period, drop in performance, or any other time and their corresponding effects on performance so that parameter determination module 124 may determine a compensation factor that compensates for the age of the actuator.

According to various implementations of the invention, the compensation factor may include an indication of the voltage supplied to the actuator that compensates for the age of the actuator. For example, parameter determination module 124 may determine a level of voltage should be supplied to the actuator based on the aging information. Thus, according to various implementations of the invention, the actuator at a first age may generate a greater force than desired. Accordingly, parameter determination module 124 may determine a decreased top-line voltage level in order to cause the actuator to output less force at the first age. According to various implementations of the invention, the actuator at a second age may generate a lesser force than desired. As such, parameter determination module 124 may determine an increased level of top-line voltage level in order to cause the actuator to output more force at the second age. Thus, in the foregoing examples, by determining the level of voltage to be supplied to the actuator based on the age of the actuator, parameter determination module 124 may compensate for the effects of aging on the actuator.

According to various implementations of the invention, parameter determination module 124 may use the sensor information (described above with regard to the aging information) in order to compensate for the effects of aging on the actuator. For example, parameter determination module 124 may determine the compensation factor based on the sensor information. According to various implementations of the invention, the sensor information may indicate, for instance, that the actuator is not providing a desired level of force. Thus, parameter determination module 124 may determine parameters that compensate for this effect, such as by determining an increased top-line voltage level. In this manner, parameter determination module 124 may determine the one or more parameters “on-the-fly” based on the sensor information.

According to various implementations of the invention, parameter determination module module 124 may operate based on a closed loop feedback. For example, age compensation module 120 may determine a problem with actuator performance (such as when the actuator is not performing appropriately based on a comparison to a baseline or normal operation standard). Age compensation module 120 may generate a new model that compensates for the problematic performance of the actuator.

According to various implementations of the invention, parameter determination module 124 may generate a model that compensates for decreased acceleration performance of the actuator. In these implementations, a control signal include a kickpulse may be generated in order to compensate for the decreased acceleration performance. In some implementations of the invention, the model may compensate for excessive force, such as after a break-in period (or otherwise for an actuator that produces forces stronger than desired). In these implementations, the generated control signal may include a braking pulse. In this manner, the model may compensate for various effects of age or other condition on actuators.

According to various implementations of the invention, parameter determination module 124 may store the compensation factor and/or the one or more parameters in a memory such as memory 128 and/or other storage for later retrieval. In this manner, the compensation factor and/or the one or more parameters may be used to generate the control signal while the actuator performs consistently (i.e., is not yet affected by the age of the actuator). For example, the performance of the actuator may not be affected by a particular change in age. In other words, an actuator may perform substantially the same at an earlier age as compared to the actuator at a later age. Thus, the one or more parameters may be used for both the earlier age and the later age in the preceding example. In this example, when parameter determination module 124 determines that the age of the actuator does not warrant updating the one or more parameters, the stored one or more parameters from the prior age of the actuator may be used.

According to various implementations of the invention, parameter determination module 124 may determine whether to update the one or more parameters (such as with a compensation factor) based on whether the actuator is performing inconsistently (e.g., based on the sensor information) and/or is predicted to perform inconsistently as the actuator ages (e.g., based on the model of the actuator). The one or more parameters may be updated at various times. For example, the one or more parameters may be updated at particular ages of the actuator, at changes in performance and/or other characteristic that warrants a change in the one or more parameters, and/or other appropriate indication that the age of the actuator is resulting in inconsistent performance over time. For example, the one or more parameters may be updated when certain ages of the actuator are achieved (such as when the actuator has been actuated a predefined number of instances), when the change in force output of the actuator exceeds a predetermined threshold, and/or other indications that the age of the actuator results in inconsistent performance.

According to various implementations of the invention, the one or more parameters may be used as part of an existing haptic library that includes a plurality of haptic effects. In other words, various implementations of the invention may be used to modify existing haptic libraries of existing haptic enabled devices in order to compensate for the effects of aging on the actuator.

According to various implementations of the invention, output module 126 may generate the control signal based on the one or more parameters. For example, the one or more parameters may indicate the level of voltage that should be supplied to the actuator. Output module 126 may encode or otherwise generate the control signal to indicate the voltage, causing the actuator to use the voltage indicated. In this manner, age compensation module 120 may generate the control signal in response to the aging information, thereby compensating for the effect of age on the actuator.

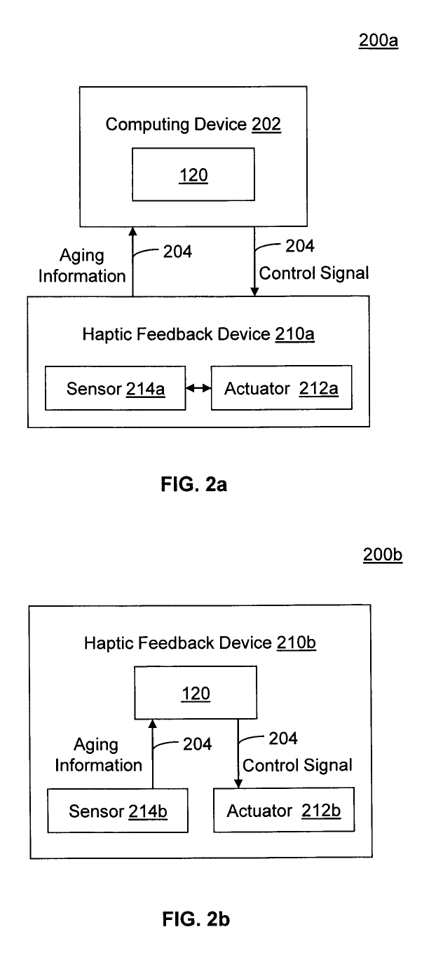

FIG. 2a is a block diagram of an example system 200a for compensating for the effects of aging on actuators, according to various implementations of the invention. According to various implementations of the invention, system 200a includes a computing device 202 communicably coupled to a haptic feedback device 210a via a link 204. Computing device 202 may include, among other things, aging compensation module 120 described above with respect to FIG. 1. Haptic feedback device 210a may include, among other things, one or more actuators 212a (“actuator 212a”) and one or more sensors 214a (“sensor 214a”). Link 204 may be a network (such as the Internet, Ethernet, wireless network, and/or other network), a Universal Serial Bus (USB) link, and/or other link that facilitates communication between computing device 202 and haptic feedback device 210a.

According to various implementations of the invention, computing device 202 may be a laptop computer, a desktop computer, a server that includes one or more processors (not shown), a Personal Digital Assistant (PDA), a smartphone, and/or other computing device configured to provide one or more functions of aging compensation module 120. Haptic feedback device 210a may be a touchpad, a laptop computer, a computer peripheral such as a computer mouse or keyboard, a PDA, a smartphone, and/or other device that generates haptic feedback.

According to various implementations of the invention, computing device 202 may use aging compensation module 120 to receive the aging information from haptic feedback device 210a and output one or more control signals that compensate for the effect of age of actuator 212a. Thus, according to various implementations of the invention, the control signal may be remotely generated from the haptic feedback device 210a.

According to various implementations of the invention, aging compensation module 120 may determine a compensation factor that compensates for the age of actuator 212a. For example, the age of actuator 212a may affect the offset, gain, and/or other factor that affects performance of actuator 212a. The compensation factor may, for example, be additive for offsets and multiplicative for gains, and/or other factor compensating for the effects of the age of actuator 212a, thereby compensating for such effects.

FIG. 2b is a block diagram of an example system 200b for compensating for the effects of aging on actuators, according to various implementations of the invention. According to various implementations of the invention, system 200a includes a haptic feedback device 210b, may include, among other things, aging compensation module 120 described above with respect to FIG. 1, one or more actuators 212b (“actuator 212b”) and one or more sensors 214b (“sensor 214b”).

Haptic feedback device 210b may be a touchpad, a laptop computer, a computer peripheral such as a computer mouse or keyboard, a PDA, a smartphone, and/or other device that generates haptic feedback. According to various implementations of the invention, haptic feedback device 210b may use aging compensation module 120 to receive the aging information and output one or more control signals that compensate for the effect of age of actuator 212b. Thus, according to various implementations of the invention, the control signal may be generated by haptic feedback device 210b.

FIG. 3a is a two-dimensional graph 300 illustrating an example of a force output profile 310 of an actuator as the actuator ages. According to various implementations of the invention, axis 302 illustrates levels of force output by an actuator (such as actuator 212a and/or 212b) versus axis 304, which illustrates ages 1-8 of the actuator. Force output profile 310 illustrates the force output by the actuator over time. The force output may be measured (such as by sensor 214a and/or sensor 214b) and/or predicted by the model of the actuator described above. Baseline 320 illustrates a desired level of force (such as the force output desired by a haptic effects designer, for example). In this example, graph 300 illustrates that the actuator produces the desired level of force of baseline 320 at ages 0 to 1 and 6-7. The actuator produces a greater force than baseline 320 at ages 1-6 and produces lesser force than baseline 320 at ages 7-8. Ages 1-6 may represent the break-in period described above, where the actuator generates more force as the actuator ages.

FIG. 3b is an example aging offset table 340 illustrating an example voltage compensation factor that compensates for the effects of the age of the actuator, the force output profile of which is depicted in FIG. 3a. As previously noted, at ages 0 to 1 and 6-7, the actuator produces the desired level of force illustrated by baseline 320. Thus, at these ages, aging offset table 302 is predefined such that the voltage level is not changed. At ages 1-6, when the actuator produces a greater level of force than the desired level, aging offset table 302 may be predefined such that the voltage parameter indicates that the voltage is to be decreased as compared to when the actuator produces the desired level of force. In some implementations of the invention, kickpulse and braking time duration may be reduced as they take advantage of maximum available voltage. At age 8, when the actuator produces a lesser level of force than the desired level, aging offset table 302 may be predefined such that the voltage parameter indicates that the voltage is to be increased as compared when the actuator produces the desired level of force. In some implementations of the invention, kickpulse and braking time duration may be increased. Thus, by predicting and/or measuring the behavior of the actuator, aging offset table 302 may be used to compensate for the effects of aging on the actuator.

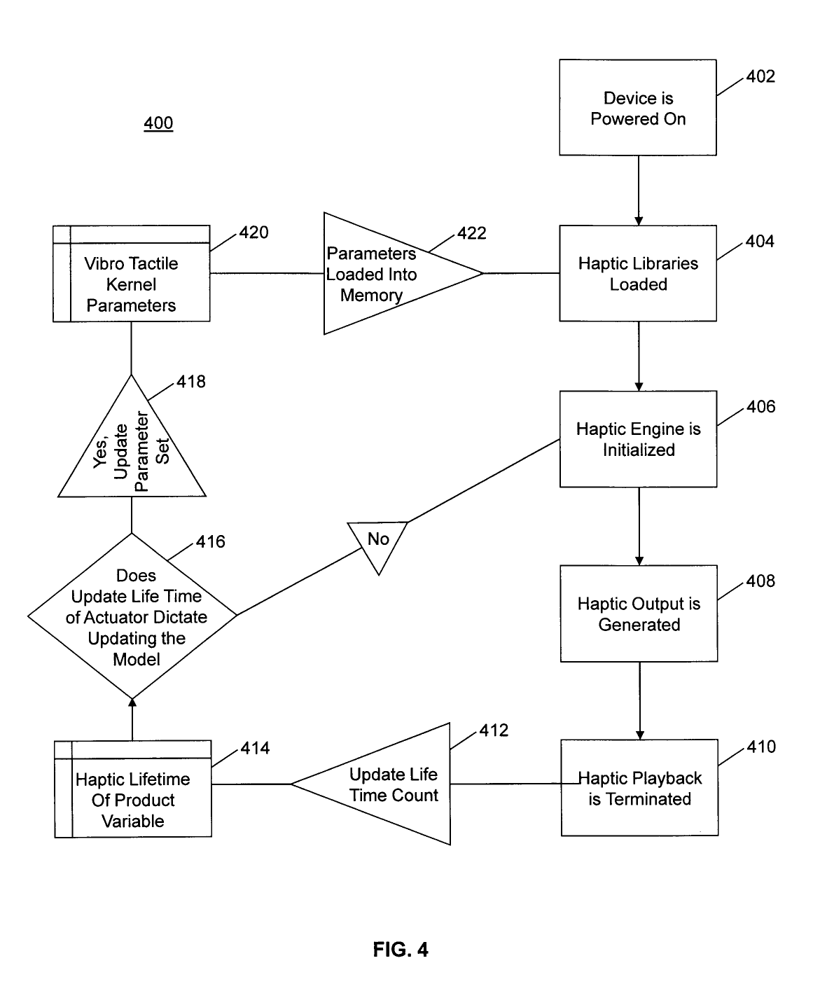

FIG. 4 is a flow diagram of an example process 400 for compensating for the effects of aging on actuators, according to various implementations of the invention. The various processing operations depicted in the flow diagram of FIG. 4 (and in the other drawing figures) are described in greater detail herein. The described operations for a flow diagram may be accomplished using some or all of the system components described in detail above and, in some implementations, various operations may be performed in different sequences. According to various implementations of the invention, additional operations may be performed along with some or all of the operations shown in the depicted flow diagrams. In yet other implementations, one or more operations may be performed simultaneously. Accordingly, the operations as illustrated (and described in greater detail below) are examples by nature and, as such, should not be viewed as limiting.

According to various implementations of the invention, in an operation 402, a haptic enabled device (such as, for example, haptic feedback device 210a and 210b), may be powered on. Once the haptic enabled device is powered on, in an operation 404, haptic libraries may be loaded. The haptic libraries may include the one or more parameters that may be used to generate a control signal to an actuator of the haptic enabled device. The control signal may cause the actuator to generate one or more haptic effects that are output via the haptic enabled device. In an operation 406, a haptic engine may be initialized with the haptic libraries. For example, the haptic engine may load the haptic libraries into a memory in order to render one or more haptic effects from the haptic libraries. In an operation 408, the haptic engine may cause the one or more haptic effects to be delivered to the haptic feedback device. For example, the haptic engine may determine the one or more parameters to generate a control signal that is communicated to the actuator of the haptic feedback device.

Once the haptic feedback is terminated in an operation 410, a life time count may be updated in an operation 412. Thus, a haptic life time of product variable 414 is updated. For example, the haptic life time of product variable 414 may include the aging variable described above. The haptic life time of product variable 414 may be incremented to indicate that the actuator has been actuated, thereby updating the age of the actuator. In an operation 416, process 400 may determine whether the updated haptic life time of product variable 414 dictates updating the model of the actuator and/or the one or more parameters of the haptic libraries. For instance, the haptic life time of product variable 414 may be compared to one or more predefined ages that dictate that the model of the actuator and/or the one or more parameters of the haptic libraries should be updated. In a non-limiting example, the haptic life time may be one million cycles and the predetermined age may be 100,000 cycles so that at 100,000 cycle intervals (i.e., an age metric), the one or more parameters may be changed in order to compensate for the age of the actuator. In this manner, the model may be predict and compensate for the effects of age on actuators.

If in operation 416, the haptic life time of product variable 414 does not dictate updating the model of the actuator and/or the one or more parameters of the haptic libraries, then processing may proceed to operation 406, wherein the haptic engine is initialized. In other words, the next haptic effects may be generated using the same parameters of the haptic libraries that were used to generate the preceding haptic effects.

If in an operation 416, the haptic life time of product variable 414 dictates updating the model of the actuator and/or the one or more parameters of the haptic libraries, then processing may proceed to an operation 418, wherein the one or more parameters of the haptic libraries may be updated to generate updated vibrotactile kernel parameters 420 (such as the one or more parameters described above). In other words, in operation 418, process 400 may compensate for the effects of aging on the actuator by updating the one or more parameters that control the behavior of the actuator. As previously noted, a compensation factor may be determined that changes a voltage parameter, is additive for offsets, multiplicative for gains, and/or other appropriate factor that compensates for the effects of age of the actuator.

In an operation 422, the updated parameters may be loaded into a memory (such as memory 128). Processing may then proceed to operation 404, wherein the haptic libraries, which now include the updated parameters, are loaded. In other words, the next haptic effects may be generated using different parameters of the haptic libraries as compared to parameters that were used to generate the preceding haptic effects. In this manner, the one or more parameters of the haptic libraries have been updated to compensate for the effects of aging on the actuator.

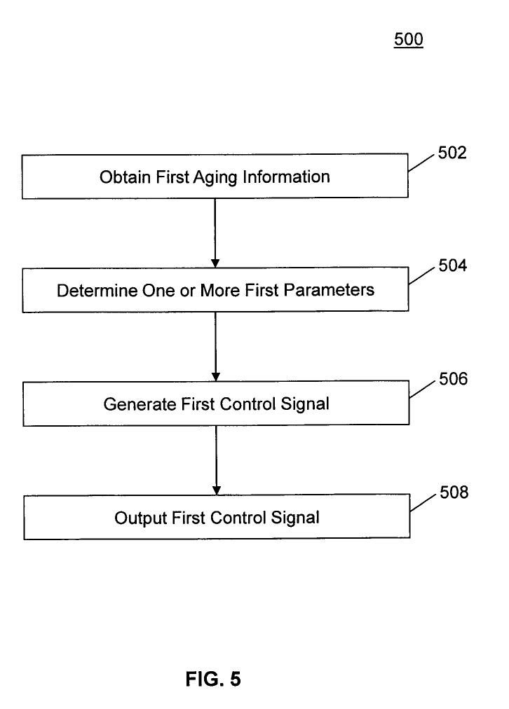

FIG. 5 is a flow diagram of an example process 500 for compensating for the effects of aging on actuators, according to various implementations of the invention. In an operation 502, first aging information of a first actuator may be obtained. The first aging information may indicate an age of the actuator. The first aging information may include, for example, a value indicating a number of instances that the first actuator has been actuated, thereby indicating the age of the first actuator. In an operation 504, a compensation factor may be determined based on the first aging information. For example, the compensation factor can be determined based on the age of the first actuator. In other words, the compensation factor may facilitate compensation of the effects of the age of the first actuator.

In an operation 506, a first control signal may be adjusted using the compensation factor. The first control signal may cause the first actuator to generate (or otherwise output) a first haptic effect. In an operation 508, the first control signal may be output to the first actuator. In this manner, the one or more first parameters may be used to generate a control signal that causes the first actuator to generate the first haptic effect. Because the one or more first parameters are determined based on the age of the first actuator, the one or more first parameters may be determined such that the behavior of the first actuator may be modified in order to compensate for the effects of the age of the first actuator. For example, when the first actuator produces less force at a later age as compared to an earlier age, the one or more first parameters may be determined such that the decrease in force may be compensated by increasing the voltage supplied to the actuator, for example.

Implementations of the invention may be made in hardware, firmware, software, or any suitable combination thereof. Implementations of the invention may also be implemented as instructions stored on a machine-readable medium, which may be read and executed by one or more processors. A tangible machine-readable medium may include any mechanism for storing or transmitting information in a form readable by a machine (e.g., a computing device). For example, a tangible machine-readable storage medium may include read only memory, random access memory, magnetic disk storage media, optical storage media, flash memory devices, and other tangible storage media. Intangible machine-readable transmission media may include intangible forms of propagated signals, such as carrier waves, infrared signals, digital signals, and other intangible transmission media. Further, firmware, software, routines, or instructions may be described in the above disclosure in terms of specific exemplary implementations of the invention, and performing certain actions. However, it will be apparent that such descriptions are merely for convenience and that such actions in fact result from computing devices, processors, controllers, or other devices executing the firmware, software, routines, or instructions.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A method for compensating for the effects of aging on a haptic actuator, comprising:
obtaining aging information of an actuator;
determining a compensation factor based on the aging information;
adjusting a control signal to be applied to the actuator based on the compensation factor, the control signal otherwise causing the actuator to generate a haptic effect; and
outputting the adjusted control signal to the actuator thereby compensating for an age of the actuator.

2. The method of claim 1, wherein the aging information includes an aging variable that is updated when the actuator is actuated.

3. The method of claim 1, wherein the aging information include sensor information originating from a sensor coupled to the actuator.

4. The method of claim 3, wherein the sensor information includes one or more measurements of the actuator while the actuator is actuated.

5. The method of claim 1, wherein said determining the compensation factor comprises:
obtaining a model of the actuator, wherein the model generates a prediction of the behavior of the actuator, and wherein the compensation factor is based at least in part on the prediction.

6. The method of claim 1, wherein said determining the compensation factor comprises:
determining one or more parameters used to generate the control signal.

7. The method of claim 6, wherein said determining the one or more parameters comprises:
looking up the one or more parameters in an age lookup table that maps the one or more parameters to the aging information.

8. The method of claim 1, wherein the compensation factor includes voltage information that indicates a change in voltage that is supplied to the actuator, thereby compensating for the age of the actuator by changing the voltage supplied to the actuator.

9. The method of claim 1, further comprising:
obtaining second aging information of a second actuator;
determining a second compensation factor based on the second aging information;
adjusting a second control signal using the second compensation factor; and
outputting the adjusted second control signal to the second actuator thereby compensating for the effects of the age of the second actuator.

10. A system for compensating for the effects of aging on actuators, comprising:
an age compensation module that includes one or more processors configured to:
obtain aging information of an actuator;
determine a compensation factor based on the aging information;
adjust a control signal to be applied to the actuator based on the compensation factor, the control signal otherwise causing the actuator to generate a haptic effect; and
output the adjusted control signal to the actuator thereby compensating for an age of the actuator.

11. The system of claim 10, wherein the aging information includes an aging variable that is updated when the actuator is actuated.

12. The system of claim 10, wherein the aging information include sensor information originating from a sensor coupled to the actuator.

13. The system of claim 12, wherein the sensor information includes one or more measurements of the actuator while the actuator is actuated.

14. The system of claim 13, wherein during said determination of the compensation factor, the age compensation module is further configured to:
obtain a model of the actuator, wherein the model generates a prediction of the behavior of the actuator, and wherein the compensation factor is based at least in part on the prediction.

15. The system of claim 10, the age compensation module further configured to:
determine one or more parameters used to generate the control signal based on the compensation factor.

16. The system of claim 15, wherein said determination of the one or more parameters comprises a look up of the one or more parameters in an age lookup table that maps the one or more parameters to the aging information.

17. The method of claim 10, wherein the compensation factor includes voltage information that indicates a change in voltage that is supplied to the actuator, thereby compensating for the age of the actuator by changing the voltage supplied to the actuator.

18. A haptic feedback device for compensating for the effects of aging on actuators, comprising:
an actuator; and
an age compensation module that includes one or more processors configured to:
obtain aging information of an actuator;
determine a compensation factor based on the aging information;
adjust a control signal to be applied to the actuator based on the compensation factor, the control signal otherwise causing the actuator to generate a haptic effect; and
output the adjusted control signal to the actuator thereby compensating for an age of the actuator.

19. The haptic feedback device of claim 18, further comprising:
a sensor coupled to the actuator, wherein the sensor generates sensor information.

20. The haptic feedback device of claim 19, wherein the sensor information includes one or more measurements of the actuator while the actuator is actuated.
